(19) United States
(12) Patent Application Publication
(10) Pub. No.: US 2023/0220776 A1
(43) Pub. Date: Jul. 13, 2023

(54) BLADE WITH ASYMMETRIC LEADING EDGE PROFILE FOR A GAS TURBINE

(71) Applicant: MTU Aero Engines AG, Munich (DE)

(72) Inventor: Sven-Juergen HILLER, Munich (DE)

(21) Appl. No.: 18/149,679

(22) Filed: Jan. 4, 2023

(30) Foreign Application Priority Data
Jan. 7, 2022 (DE) 102022100315.9

(51) Int. Cl. F01D 5/14; F01D 9/04

(52) U.S. Cl. CPC F01D 5/141; F01D 9/041; F05D 2240/303; F05D 2220/32

(57) ABSTRACT

A gas turbine has blades. A blade may have a leading edge; a trailing edge; a pressure side and a suction side, which extend between the leading edge and the trailing edge. The blade has, along the leading edge, a leading edge profile with profile portions, each of which, along its profile portion length, transitioning, proceeding from a depression, into an elevation via a first transition portion and back into a next depression via a second transition portion. An apex of the elevation of a profile portion is arranged in an asymmetric manner in relation to the profile portion length, in such a way that the first transition portion has a first transition length and the second transition portion has a second transition length. The first transition length and the second transition length are different lengths.

### CROSS REFERENCE TO RELATED APPLICATIONS

This application claims benefit to German Patent Application No. DE 102022100315.9, filed on Jan. 7, 2022, which is hereby incorporated by reference herein.

### FIELD

The present disclosure relates to a blade, in particular a rotor blade or a guide blade, for a gas turbine.

### BACKGROUND

The prior art discloses various corrugated leading edge profiles in which the profile portions are configured in a symmetric manner with respect to an incident-flow angle. Reference is made by way of example to U.S. Pat. No. 10,113,431 B2 or to US 2013/0056585 A1. Furthermore, technical articles relating to such leading edge profiles are also known, such as: GT2021-58798 by S. Sidhu et al., “Performance evaluation of leading edge tubercles applied to the blades in a 2-d compressor cascade”; or GT2021-58747 by C. Cuciumitam et al., “Structural integrity of serrated leading edge guide vane blades for noise reduction.”

The symmetric leading edge profiles in the prior art have the disadvantage that two counter-rotating vortices are generated downstream of the corrugated, symmetric leading edge profile, the vortices interacting strongly with one another and decaying rapidly on account of dissipative effects. Along the profile extent (span), regions are alternately generated which can be described by a flow perpendicularly toward the profile surface and, next to it, a flow away from the profile surface. However, the inventors have recognized that, flow structures of this kind are disadvantageous for stabilization of a boundary layer close to separation.

As used herein, directional indications such as “axial” or “axially”, “radial” or “radially” and “circumferential” are fundamentally to be understood as relating to the machine axis of the gas turbine, unless the context contains explicit or implicit indications otherwise. In particular, such directional indications in relation to the rotor blade can be understood as meaning the rotor blade is described in relation to its mounted state in a gas turbine.

### SUMMARY

In an embodiment, the present disclosure provides a blade for a gas turbine. The blade has a leading edge; a trailing edge; a pressure side and a suction side, which extend between the leading edge and the trailing edge. The blade has, along the leading edge, a leading edge profile with a plurality of profile portions, each of the profile portions, along its profile portion length, transitioning, proceeding from a depression, into an elevation via a first transition portion and back into a next depression via a second transition portion. An apex of the elevation of each of the profile portions is arranged in an asymmetric manner in relation to the respective profile portion length, in such a way that the respective first transition portion has a first transition length and the respective second transition portion has a second transition length. The respective first transition length and the respective second transition length are different lengths.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a simplified schematic illustration of a schematic diagram of an aero gas turbine;

FIG. 2 shows a simplified schematic illustration of a rotor blade with leading edge profile;

FIG. 3 shows an enlarged view of a portion of a leading edge profile; and

FIG. 4 shows vortices that may be generated downstream of the leading edge of a rotor blade.

### DETAILED DESCRIPTION

Aspects of the present disclosure specify a blade with which disadvantageous flow structures can be avoided.

According to an aspect of the present disclosure, a blade, in particular a rotor blade or a guide blade, is provided for a gas turbine, in particular an aero gas turbine, having a leading edge, a trailing edge, a pressure side and a suction side, which extend between the leading edge and the trailing edge, the blade having, along the leading edge, a leading edge profile with a plurality of profile portions, each profile portion along its profile portion length transitioning, proceeding from a depression, into an elevation via a first transition portion and back into a next depression via a second transition portion. Provision is made in this case for an apex of the elevation of each profile portion to be arranged in an asymmetric manner in relation to the respective profile portion length, in such a way that the first transition portion has a first transition length and the second transition portion has a second transition length, the first transition length and the second transition length having different lengths.

By means of such asymmetric profiling, vortices of unequal size, usually a larger vortex and a smaller, counter-rotating vortex, are generated downstream of the leading edge. As a result of the different size of the vortices formed, dissipative processes are less pronounced and the aerodynamic effect of the larger vortex is present further downstream. The larger vortex generated by the asymmetric profile shape also exhibits a better boundary-stabilizing effect.

In the case of the blade, in relation to a radial direction of the blade, in particular proceeding from a blade root in the direction of a blade tip, the profile portions are configured in such a way that in each case the first transition length is shorter than the second transition length. It is generally pointed out that the sequence of first and second transition length does not necessarily have to be from radially inside to radially outside. Rather, the asymmetric profiling may also be embodied in a converse manner, such that the sequence of first and second transition length is provided from radially outside to radially inside.

In the case of the blade, a gradient of the first transition portion may be greater than a gradient of the second transition portion.

In the case of the blade, the first transition length may be approximately 10% to 40% of the profile portion length and the second transition length may be approximately 60% to 90% of the profile portion length.

In the case of the blade, the first transition portion and the second transition portion may be configured in a substantially rectilinear manner or with a respective, substantially constant radius of curvature. In particular, the transition portions may be configured such that their course does not contain any change in curvature from concave to convex, or vice versa.

A blade ring, in particular a rotor blade ring or a guide blade ring, for a gas turbine, in particular an aero gas turbine, may be embodied with a plurality of blades, as described above, which are arranged adjacently to one another in a circumferential direction.

A gas turbine, in particular an aero gas turbine, may be embodied with at least one compressor-side blade ring and/or at least one turbine-side blade ring, a plurality of blades as described above being arranged in the circumferential direction on the compressor-side blade ring and/or on the turbine-side blade ring.

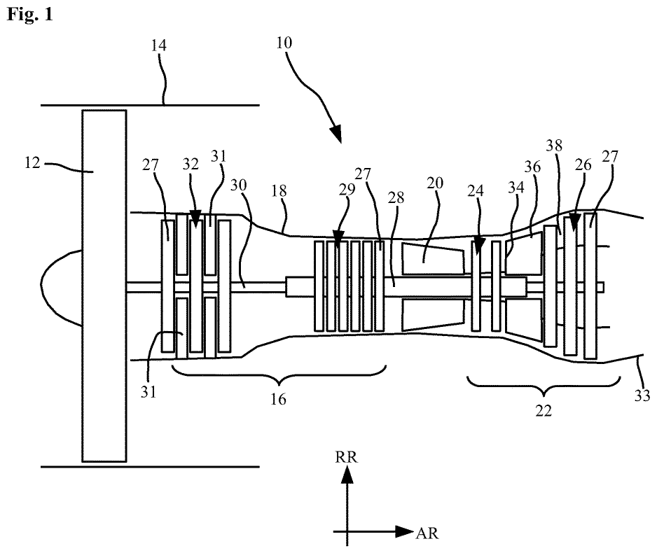

FIG. 1 shows a schematic and simplified illustration of an aero gas turbine 10, which has been illustrated merely by way of example as a turbofan engine. The gas turbine 10 comprises a fan 12, which is surrounded by an indicated shell 14. In an axial direction AR of the gas turbine 10, the fan 12 is adjoined by a compressor 16 which is accommodated in an indicated inner casing 18 and which may be of one-stage or multi-stage configuration. The compressor 16 is adjoined by the combustion chamber 20. Hot exhaust gas flowing out of the combustion chamber then flows through the adjoining turbine 22, which may be of one-stage or multi-stage configuration. In the present example, the turbine 22 comprises a high-pressure turbine 24 and a low-pressure turbine 26. A hollow shaft 28 connects the high-pressure turbine 24 to the compressor 16, in particular to a high-pressure compressor 29, with the result that these are driven or rotated together. A shaft 30 located further inward in a radial direction RR of the turbine connects the low-pressure turbine 26 to the fan 12 and to a low-pressure compressor 32, with the result that these are driven or rotated together. The turbine 22 is adjoined by a thrust nozzle 33, which is only indicated here.

In the illustrated example of an aero gas turbine 10, a turbine intermediate casing 34, which is arranged around the shafts 28, 30, is arranged between the high-pressure turbine 24 and the low-pressure turbine 26. Hot exhaust gases from the high-pressure turbine 24 flow through the radially outer region 36 of the turbine intermediate casing 34. The hot exhaust gas then passes into an annular space 38 of the low-pressure turbine 26. Rotor blade rings 27 of the compressors 16, 32 and the turbines 24, 26 are illustrated by way of example. For the sake of clarity, guide blade rings 31 which are usually present are illustrated by way of example only for the compressor 32.

The following description of one embodiment of the present disclosure relates in particular to one or more blades, in particular rotor blades or guide blades, which may be arranged on the compressor side or on the turbine side in the aero gas turbine 10.

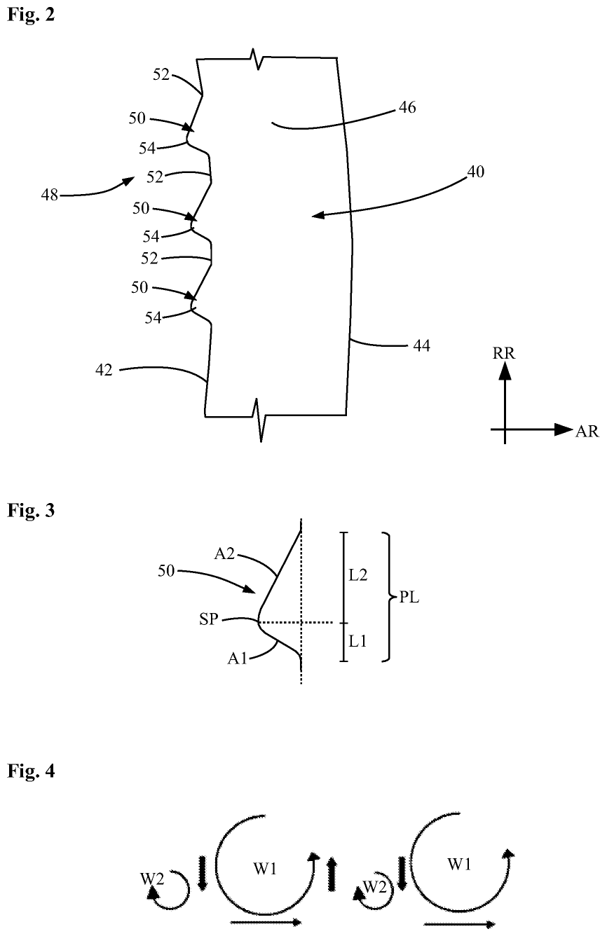

FIG. 2 shows a simplified and schematic illustration of a partial view of a rotor blade 40 as an example of a blade of a gas turbine. The rotor blade 40 has a leading edge 42 and a trailing edge 44. The rotor blade 40 usually comprises a pressure side 46 and a suction side, the pressure side and suction side extending between the leading edge 42 and the trailing edge 44.

The rotor blade 40 has, along the leading edge 42, a leading edge profile 48 with a plurality of profile portions 50, each profile portion 50 along its profile portion length PL transitioning, proceeding from a depression 52, into an elevation 54 via a first transition portion A1 and back into a next depression 52 via a second transition portion A2.

The configuration of the leading edge profile 48, in particular an example of a profile portion 50, can be more clearly seen from the slightly enlarged illustration of FIG. 3.

An apex SP of the elevation 54 of each profile portion 50 is arranged in an asymmetric manner in relation to the respective profile portion length PL. In this way, the first transition portion A1 has a first transition length L1 and the second transition portion A2 has a second transition length L2, the first transition length L1 and the second transition length L2 having different lengths.

In relation to a radial direction RR of the blade 40, in particular proceeding from a blade root in the direction of a blade tip, the profile portions 50 may be configured in such a way that in each case the first transition length L1 is shorter than the second transition length L2. It is pointed out that the sequence of first and second transition length L1, L2 does not necessarily have to be from radially inside to radially outside. Rather, the asymmetric profiling 48 may also be embodied in a converse manner, such that the sequence of first and second transition length L1, L2 is provided from radially outside to radially inside.

It can also be seen from FIG. 3 that a or the gradient of the first transition portion A1 is greater than a or the gradient of the second transition portion A2.

In the case of a rotor blade 40, the first transition length L1 may be approximately 10% to 40% of the profile portion length PL and the second transition length L2 may be approximately 60% to 90% of the profile portion length.

The first transition portion A1 and the second transition portion A2 may be configured in a substantially rectilinear manner or with a respective, substantially constant radius of curvature. The transition portions A1, A2 are configured such that they are substantially unchanged, that is to say are embodied without a change in curvature or similar, between the respective depression and elevation.

By means of an above-described asymmetric profiling 48, vortices W1, W2 of unequal size, usually a larger vortex W1 and a smaller, counter-rotating vortex W2, are generated downstream of the leading edge 42, this being illustrated in simplified form in FIG. 4. As a result of the different size of the vortices formed, dissipative processes are less pronounced and the aerodynamic effect of the larger vortex W1 is present further downstream. The larger vortex W1 generated by the asymmetric profile shape also exhibits a better boundary-stabilizing effect.

The dimensioning of the leading edge profile 48 or of the various profile portions 50, such as height of the apex (maximum extent counter to the incident flow), ratio of the dimensions of L1 and L2, radii of curvature of the transition portions A1, A2, may be effected on the basis of aerodynamic and geometric variables, for instance Mach number (subsonic, transonic), Reynolds number range, ratio of profile thickness to profile length, curvature profile of the suction side and pressure side and of the blade chords.

What has been described with reference to FIGS. 2 and 3 for the example of the rotor blade 40 can also be implemented in a similar or analogous manner for a guide blade. An above-described asymmetric profiling 48 can be employed both on rotor blades and on guide blades of a gas turbine, in particular an aero gas turbine.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE DESIGNATIONS

10 Aero gas turbine
12 Fan
14 Shell
16 Compressor
18 Inner casing
20 Combustion chamber
22 Turbine
24 High-pressure turbine
26 Low-pressure turbine
27 Rotor blade ring
28 Hollow shaft
29 High-pressure compressor
30 Shaft
31 Guide blade ring
32 Low-pressure compressor
33 Thrust nozzle
34 Turbine intermediate casing
36 Radially outer region
38 Annular space
40 Rotor blade
42 Leading edge
44 Trailing edge
46 Pressure side
48 Leading edge profile
50 Profile portion
52 Depression
54 Elevation
A1, A2 Transition portion
L1, L2 Transition length
PL Profile portion length
SP Apex
W1, W2 Vortex
AR Axial direction
RR Radial direction

1. A blade for a gas turbine, the blade comprising:
a leading edge;
a trailing edge;
a pressure side and a suction side, which extend between the leading edge and the trailing edge,
wherein the blade comprises, along the leading edge, a leading edge profile with a plurality of profile portions, each of the profile portions, along its profile portion length, transitioning, proceeding from a depression, into an elevation via a first transition portion and back into a next depression via a second transition portion, and
wherein an apex of the elevation of each of the profile portions is arranged in an asymmetric manner in relation to the respective profile portion length, in such a way that the respective first transition portion has a first transition length and the respective second transition portion has a second transition length, the respective first transition length and the respective second transition length being different lengths.

2. The blade as claimed in claim 1, wherein, in relation to a radial direction of the blade, proceeding from a blade root in a direction of a blade tip, the profile portions are configured in such a way that, in each case, the respective first transition length is shorter than the respective second transition length.

3. The blade as claimed in claim 1, wherein, in each case, a gradient of the respective first transition portion is greater than a gradient of the respective second transition portion.

4. The blade as claimed in claim 1, wherein, in each case, the respective first transition length is approximately 10% to 40% of the respective profile portion length and the respective second transition length is approximately 60% to 90% of the respective profile portion length.

5. The blade as claimed in claim 1, wherein, in each case, the respective first transition portion and the respective second transition portion are configured in a substantially rectilinear manner or with a respective, substantially constant radius of curvature.

6. A blade ring, for the gas turbine, the blade ring comprising a plurality of blades each configured according to the blade claimed in claim 1, the blades being arranged adjacently to one another in a circumferential direction.

7. The gas turbine comprising at least one compressor-side blade ring and/or at least one turbine-side blade ring, wherein a plurality of blades, each configured according to the blade claimed in claim 1, being arranged in a circumferential direction on the compressor-side blade ring and/or on the turbine-side blade ring.
